(19) United States
(12) Patent Application Publication
(10) Pub. No.: US 2008/0173294 A1
(43) Pub. Date: Jul. 24, 2008

(54) PLATFORM MINUTE ADJUSTMENT, EXPANSION AND WATER COLLECTION DEVICES

(76) Inventor: Yuehting Chen, Fongyuan City (TW)

Correspondence Address: Yuehting CHEN, P. O. Box 697, Fongyuan City, Taichung County, 420, omitted

(21) Appl. No.: 11/707,927

(22) Filed: Feb. 20, 2007

(30) Foreign Application Priority Data
Jan. 19, 2007 (TW) 096201052

(51) Int. Cl. B28D 7/04

(52) U.S. Cl. 125/35

(57) ABSTRACT

A platform minute adjustment, expansion and collection device for a stone cutter includes a water tank supported by a pair of racks, a pair of guide rods spacedly bridged on the racks, a first water collection plate and a second water collection plate, both of which are slantly disposed to a front rack, a platform having a pair of rotors on the lower side thereof and slidably engaged on the inner sides of the guide rod. The platform has a pair of expansion plates for enlarging its size and for cutting a large-sized working piece, and two minute adjusting devices mounted on the tops of the racks for displacing the platform slightly, such that the sawdust may be stopped scattering all over the working place.

### BACKGROUND OF THE INVENTION

The present invention relates to cutting machines ad more particularly to a platform minute adjustment, expansion and water collection devices for a stone cutter in which the platform has two expansion portions and at least a water collection member.

Portable stone cutter has limited area. It is troublesome for the operation to cutter large sized working pieces. Beside, the cutting working pieces, no matter it is a stone, metal or wood, under the high speed of the saw blade, the sawdust must rise up and mostly splash to the front side of the platform although a water sink disposed under the platform, to avoid the sawdust from repeatedly rising up, but the result is limitative that causes the operator or ambient people to breath the sawdust into their respiratory organs that seriously affect their lungs.

Further, convention stone cutter has a positioning device including only a saw blade rising up or moving down actions without adjustable displacement design such that the worker must do with the platform not good enough. When there is errors, the user can do nothing but moves the working piece out that is very inconvenient and causes difficulties.

### SUMMARY OF THE PRESENT INVENTION

The present invention has a main object to provide a platform minute adjustment, expansion and water collection devices for a stone cutter which provides a first water collection plate to block the large portion of the sawdust and the foam of water.

Another object of the present invention is to provide a platform minute adjustment, expansion and water collection devices for a stone cutter which provides a second water collection plate to anchor in accordance with the expansion of the platform which makes no seam to cause the water foam and sawdust reduced to least condition.

Still another object of the present invention is to provide a platform minute adjustment, expansion and water collection devices for a stone cutter which has an expansion platform by which the working pieces are no long adjusting their position on the platform that keeps an accurate cutting.

Further object of the present invention is to provide a platform minute adjustment, expansion and water collection devices for a stone cutter which has a front expansion plate and a lateral expansion plate used to enlarge the platform.

Accordingly, the platform minute adjustment, expansion and water collection devices for a stone cutter of the present invention comprises generally:

a water sink support at front and rear ends by a pair of racks one end of which connected to a water collection plate, and a pair of guide rods parallel arranged and perpendicularly disposed on the racks,

a platform having two alignment of rotors symmetrically arranged on under side and rotatably slid on the inner sides of the guide rods so as to allow the platform for longitudinal movement,

a minute adjusting plate disposed on a rack and operated by a minute adjusting bolt which slight moves the platform, the guide rods and the water collection plate to slide about longitudinally,

thereby, the water collection plate collects and leads the water and sawdust into the water sink and the platform is capable of longitudinal minute movement to coincide with the position of the working pieces that is to heighten the cutting accuracy.

The present invention will become more fully understood by reference to the following detailed description thereof when read in conjunction with the attached drawings.

### BRIEF DESCRIPTION OF THE DRAWINGS

FIG. 1 is an exploded perspective view of the preferred embodiment of the present invention,

FIG. 2 is a perspectively to show the assembly of FIG. 1,

FIG. 3 is a plane view to show that the platform is expanded and the water collection plate hooks the platform,

FIG. 4 is a plane view to show that the platform is moving backward,

FIG. 5 is a plane view to show that the lateral expansion plate is stretching out to enlarge the size for the platform,

FIG. 6 is a cross section of the present invention,

FIG. 7 is a sectional view to show that the platform is slightly displaced under a minute adjustment, and

FIG. 8 is a perspective view of the present invention.

### DETAILED DESCRIPTION OF THE PREFERRED EMBODIMENT

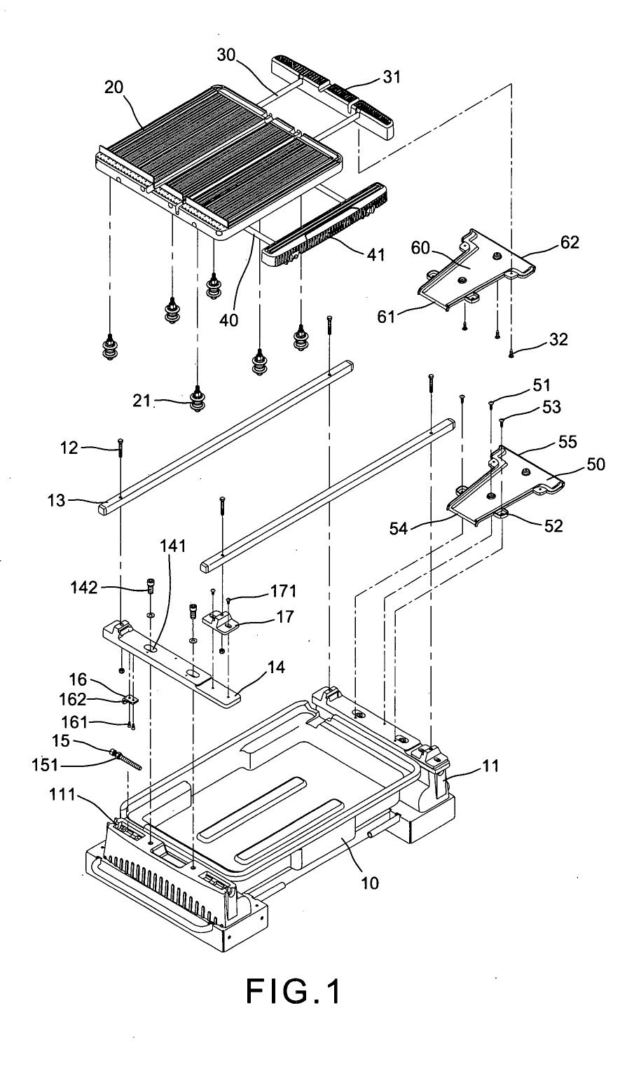

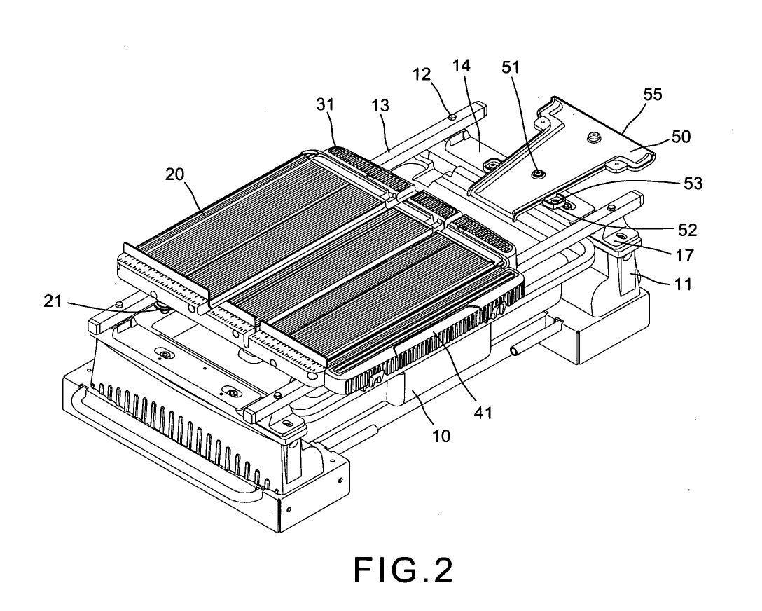

With reference to the drawings and initiated from FIGS. 1 and 2, the platform minute adjustment, expansion and water collection devices for a stone cutter of the present invention comprise generally a water sink 10, a platform 20, first pair of slidable rods 30, second pair of slidable rods 40, a first water collection plate 50 and a second water collection plate 60.

The water sink has a rectangular body, a front end and a rear end support by a pair of racks 11, a pair of the guide rods 13 parallel arranged and perpendicularly connected to the top of the racks 11 by a plurality of bolts 12. One of the racks 11 slantly connected a first water collection plate 50 which has a positioning plate 52 at lower portion connected to a top of a minute adjusting plate 14 by screws 53. The first water collection plate 50 has a downward bend at lower end 54 and an upper bend on upper end 55 which looks like a hook. The front rack 11 has a stone cutter 70 at a lateral side.

The platform 20 has two alignment of rotors 21 parallel arranged and slidably engaged with the inner side of the guide rods 13 so as to enable the platform 20 to make horizontal displacement, a pair of guide sleeves (not shown) horizontally disposed under the platform 20 for sliding a pair of sliding rods 30 therein, the outer ends of the sliding rods 30 connected to an expansion plate 31 of the platform 20, the under side of the expansion plate 31 connected the second water collection plate 60 by screws 32, the second water collection plate 60 having the same structure of the first water collection plate 50 so it having also a lower bend 61 and an upper bend 62.

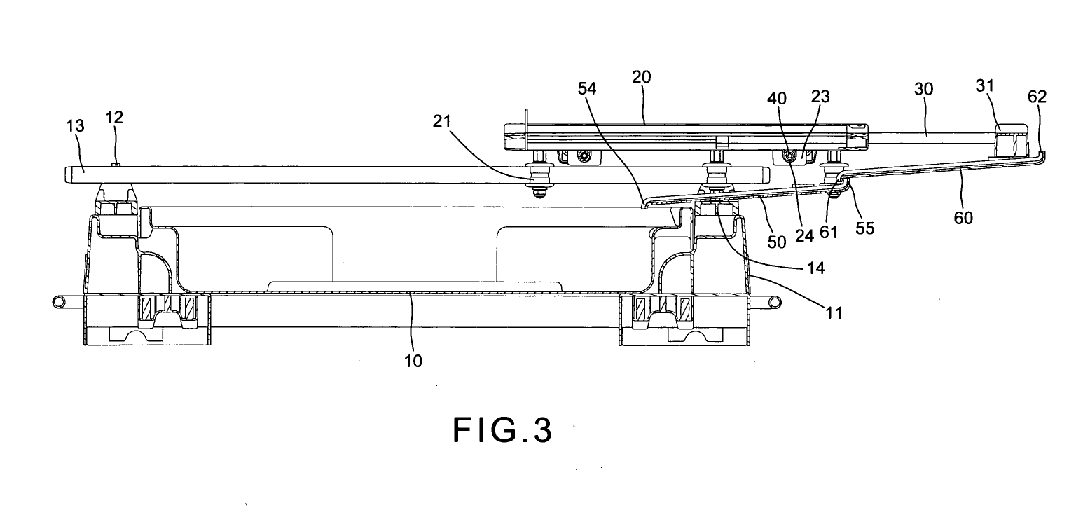

Referring to FIGS. 1 and 3, a pair of protruding rods 23 parallel and longitudinally dispose under the platform 20, each of the protruding rods 23 has a guide sleeve 24 in center for slidably disposing a pair of second sliding rods 40, the outer ends of which connected to a longitudinal expansion plate 41 of the platform 20.

The top of each of the racks 11 is pivoted a minute adjusting plate 14 and each of the racks 11 has a retaining groove 111 which is provided to receive an adjustable bolt 15 in corporation with a nut 151, the head of the bolt 15 is a depressed hexagon, the nut 151 is in the retaining groove 111, the adjustable bolt 15 only self-rotated without displacement, a positioning plate 16 has a screw hole 162 to permit the bolt 15 swiveling in and to secure to the minute adjusting plate 14 by a pair of screws 161, the minute adjusting plate 14 has a pair of oblong hole 141 for receiving a pair of bolts 142 which screw to the racks 11, the minute adjusting plate 14 further has a thin end to receive a butterfly plate 17 and is secured by a pair of screws 171, the late 17 is in turn connected to one of the guide rod 13. When use a hexagon wrench to adjust the depressed hexagon head of the bolt 15, it will cause the positioning plate 16, the minute adjusting plate 14, the guide rods 13 and the platform slightly displacing longitudinally.

In operation, the sawdust and water vapor are directly captured by the first water collection plate 50 to prevent the water vapor as well as the sawdust from diffusing to outside of the stone cutter so as to stop the containment of the fresh air.

If cutting a large sized working piece (as shown in FIG. 3), the user can pull out the expansion plate 31 to expand the platform 20. When pull out the expansion plate 31 the second water collection plate 60 is simultaneously pulled out and positioned under the sliding rod 30 and disposed on the top of the first water collection plate 50, in the same time the lower bend 61 of second water collection plate 60 hooks the upper bent 55 of the first water collection plate 50 so that the second water collection plate 60 inner portion overlaps to the outer portion of the first water collection plate 50. Thus the water vapor or sawdust through the second water collect plate 60 flows to the first water collection plate 50 which in turn flows them to the water sink 10.

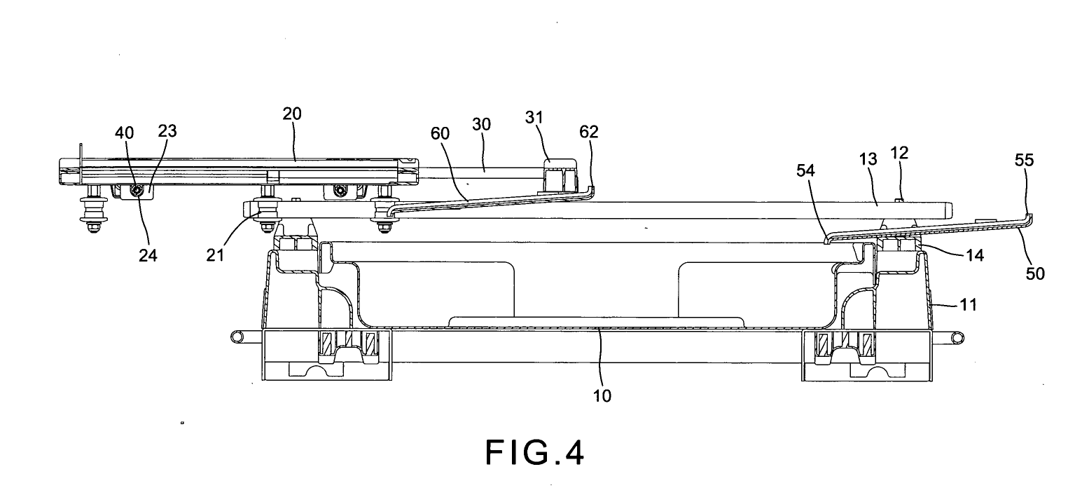

When push back the expansion plate 31 to the platform 20 (as shown in FIG. 4), the second water collection plate 60 follows the platform 20 simultaneously displace and moves out of the first water collection plate 50. Do not hinder the platform 20 perform any movement no matter the platform 20 whether or not expand, the second water collection plate 60 will follow the platform 20.

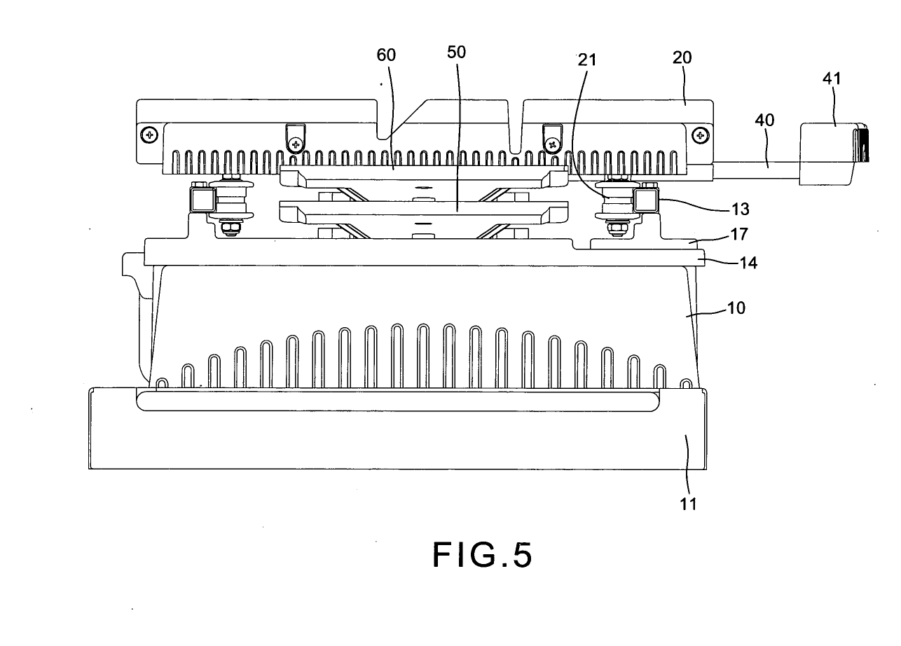

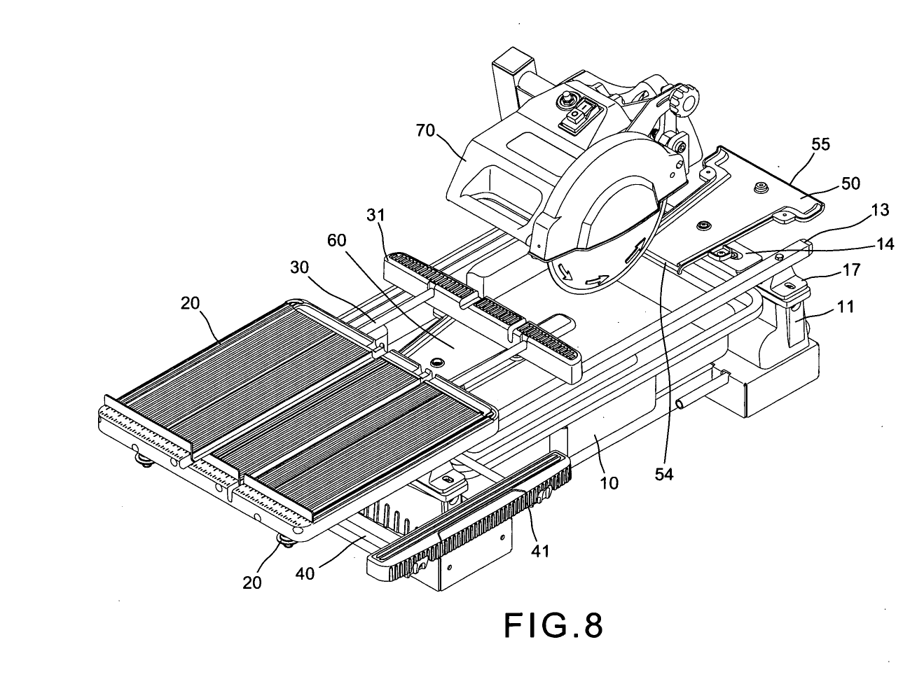

Referring to FIG. 5 if the working piece is too wide the expansion plate 41 should be pull out to coincide with working piece. This action will not hinder the first and second water collection plates 50 and 60, it is suitable to position the stone cutter on the rack 11 and don'care which is the structure of the stone cutter (as shown in FIG. 8).

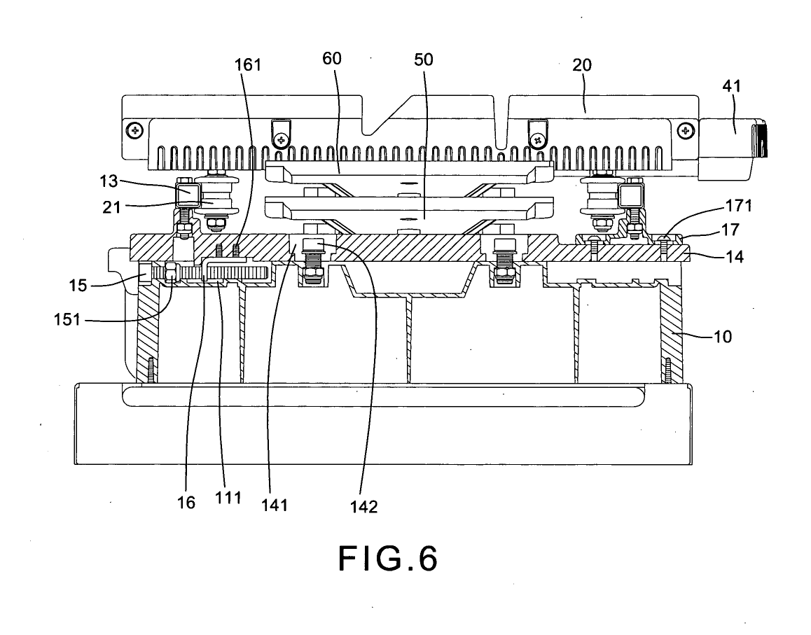

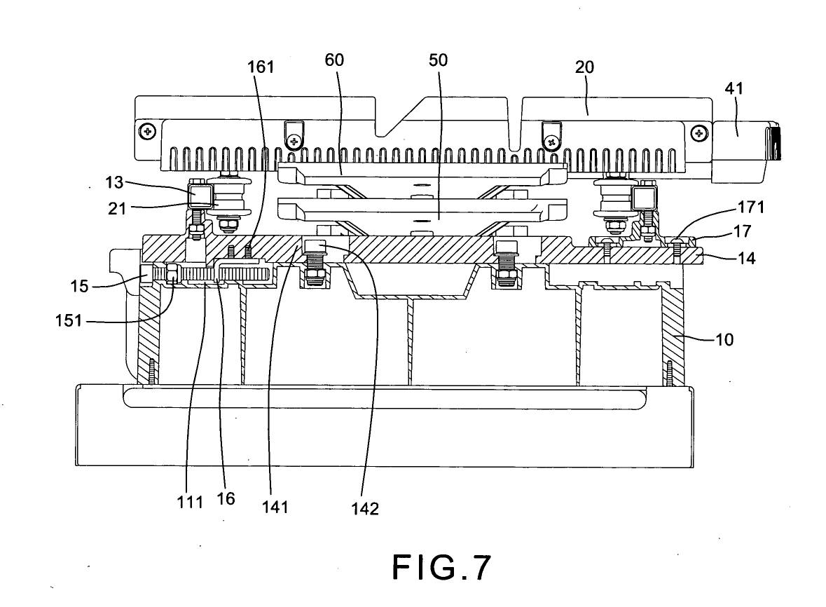

Referring FIGS. 6 and 7, when minute adjusting the platform 20, to adjust the head of the adjusting screw 15 which rotates to pushing the positioning plate 16 which in turn to affect the minute adjusting plate 14 to accurate the pair of guide rod 13, meanwhile the first water collection plate 50 performs a longitudinal minute adjustment together with platform 20 (platform 20 together with the second water collection plate 60 which also simultaneously displaced) together with working piece, same time the longitudinal displacement coincides with the cutting requirement in order to promote the cutting accuracy.

Note that the specification relating to the above embodiment should be construed as an exemplary rather than as a limitative of the present invention, with many variations and modifications being readily attainable by a person of average skill in the art without departing from the spirit or scope thereof as defined by the appended claims and their legal equivalents.

1. A platform minute adjustment, expansion and water collection device for a stone cutter comprising:
a water tank having a rectangular body, a front end and a rear end respectively supported by a pair of racks, a pair of guide rods, both of which are parallely arranged and perpendicularly connected to the tops of the racks by a plurality of bolts, one of the racks slantly being connected with a first water collection plate which has a positioning plate fixed at the lower portion thereof and connected to the top of a minute adjusting plate by using screws, wherein the first water collection plate has a lower end bending downward and a hook a hook-shaped upper end bending upward, the front rack has a stone cutter provided at the lateral side thereof;
a platform having a plurality of rotors parallely arranged and slidably engaged with the inner sides of the guide rods so as to displace the platform horizontally, a pair of guide sleeves horizontally disposed under the platform for sliding a pair of first slidable rods therein, the outer ends of the sliding slidable rods being connected to an expansion plate of the platform, the lower side of the expansion plate being connected to the second water collection plate by using screws, the second water collection plate having an upper end bending upward and a lower end bending downward; a pair of protruding rods parallely and longitudinally disposed under the platform and each having a guide sleeve at the center thereof for slidably disposing a pair of second slidable rods, the outer ends of which are connected to a longitudinal expansion plate of the platform;
a minute adjusting plate pivoted on the top of each of the racks, and each of the racks having a retaining groove which is provided to receive an adjustable bolt in cooperation with a nut, the head of the adjustable bolt being formed in the shape of a hexagon, the nut being disposed in the retaining groove, the adjustable bolt may only rotate without displacement, a positioning plate also disposed in the retaining groove and having a screw hole for permitting the bolt to be swiveled therein, the adjusting plate having oblong holes for receiving a pair of bolts which are screwed to the racks, further, the minute adjusting plates each having a thin end for receiving a butterfly plate secured by screws, the butterfly plate being in turn connected to the guide rods.
